(19) United States
(12) Patent Application Publication
(10) Pub. No.: US 2024/0303750 A1
(43) Pub. Date: Sep. 12, 2024

(54) INDIVIDUAL OR GROUP REPUTATION EVALUATION SYSTEM AND METHOD

(71) Applicant: Hyun Chul SHIN, Daejeon (KR)

(72) Inventor: Hyun Chul SHIN, Daejeon (KR)

(21) Appl. No.: 18/271,166

(22) PCT Filed: Jan. 7, 2022
(86) PCT No.: PCT/KR2022/000258

§ 371 Date: Jul. 6, 2023

(30) Foreign Application Priority Data
Jan. 8, 2021 (KR) 10-2021-0002872
Jan. 6, 2022 (KR) 10-2022-0001983

(51) Int. Cl. G06Q 50/00

(52) U.S. Cl. CPC G06Q 50/01

(57) ABSTRACT

An individual or group reputation evaluation system and method, includes: an evaluatee terminal for requesting an evaluation about the social reputation of an evaluatee; a service server for receiving the evaluation request of the evaluatee terminal and analyzing the evaluation result; an evaluator terminal, which accepts the evaluation request of the evaluatee terminal in order to respond to the evaluation provided by the service server; and a viewer terminal, which requests the evaluation result for the user of the evaluatee terminal from the service server, in order to view same.

### CROSS-REFERENCE TO PRIOR APPLICATIONS

This application is a National Stage Patent Application of International Patent Application No. PCT/KR2022/000258 (filed on Jan. 7, 2022), which claims priority to Korean Patent Application Nos. 10-2021-0002872 (filed on Jan. 8, 2021) and 10-2022-0001983 (filed on Jan. 6, 2022), which are all hereby incorporated by reference in their entirety.

### BACKGROUND

The present invention relates to a system and method for evaluating reputation of an individual or a group, and more specifically, to a system and method for evaluating reputation including multifaceted abilities such as social capability and the like.

Generally, the social reputation of an individual or a group is an evaluation mainly based on subjective opinions of individual evaluators. Therefore, the evaluation of an individual or a group being evaluated is extremely personal, and thus is difficult to objectify.

Here, the evaluation of an individual or a group may refer to social capability (social ability or social reputation) such as social credit, temperament, work ability, personality, and the like of the individual or group.

Techniques for evaluating individual work ability are disclosed in Korean Patent Registration No. 10-1998240 (Method for Evaluating and Analyzing of Job Ability by Job Ability Evaluation Model and System of the Same, registered on Jul. 5, 2019), Korean Laid-opened Patent No. 10-2001-0097430 (Internet Based Customer Annual Salary Valuation System, published on Nov. 8, 2001), and the like.

These conventional evaluation methods, either analyze and evaluate individual/team job abilities based on past job performance records within a company (Korean Patent Registration No. 10-1998240), or calculate a reasonable salary using objective indicators such as various statistics or survey figures (Korean Laid-opened Patent No. 10-2001-0097430), but they could not reflect the social reputation of an individual or a group that cannot be captured by public and formalized quantitative indicators.

Particularly, although the use of social network services by individuals or groups is very active recently, a practical reputation evaluation by meaningful evaluators who maintain or had a social relationship with the individual or group being evaluated is required, rather than a fragmentary evaluation by unrelated evaluators who view and judge posts, which can appear superficially.

### SUMMARY

Therefore, the present invention has been made in view of the above problems, and it is an object of the present invention to provide a platform capable of evaluating, by a plurality of evaluators, social ability of an individual or a group being evaluated.

In addition, another object of the present invention is to provide an evaluation system and method capable of providing objective and highly reliable evaluation results.

In order to achieve the aforementioned objective, according to one aspect of the present invention, there is provided a social reputation evaluation system for individuals or groups comprising: (a) an evaluatee terminal where the evaluatee connects to the following service server to request an evaluation of his/her social reputation; (b) a service server that receives an evaluation request from the evaluatee via the aforementioned evaluatee terminal, stores the response values submitted by the evaluator for the given question(s) for evaluating the reputation (hereafter referred to simply as ‘question(s)’) through the undermentioned evaluator terminal, analyzes the response values to derive evaluation values, and allows the evaluation values to be viewed through the evaluatee terminal or the following viewer terminal; (c) an evaluator terminal, which is predetermined, where the evaluator submits response values to the questions provided by the service server; and (d) a viewer terminal, where the viewer views the evaluation values for the evaluatee from the service server.

According to another aspect of the present invention, there is provided a social reputation evaluation method for individuals or groups performed in the aforementioned system, where the service server requires the qualifications of the evaluator and the minimum number of evaluators for each type of questions when the evaluation is requested, the evaluatee, when requesting the evaluation, designates one or more evaluators who satisfies the qualifications and numbers required by the service server, a service server provides information about the evaluatee to the designated evaluator terminal to confirm to participate in the evaluation and only sends questions to the evaluator terminal that has confirmed to participate.

In the present invention, it is desirable that the service server provides a predetermined electronic resume form to the evaluatee and the evaluator to confirm the social relationship between the evaluatee and the evaluator (hereafter referred to simply as ‘social relationship’), and receives their input.

In the present invention the questions could be classified into two major domains of questions for private relationship reputation (E) and public relationship reputation (P), depending on the social relationship. Furthermore, each major domain may be divided into sub-domains for the reputations on personality & character, credibility, future potential, fairness, trust, honesty, sincerity, concentration/achievement on goals, affinity, collaboration ability, altruism.

For instance, the major domain for the private relationship reputation (E) could be divided into sub-domains for the reputations on personality & character (E_{PC}), credibility (E_{CR}) and future potential (E_{F}). And the major domain for the public relationship reputation (P) could be divided into sub-domains for the reputations on personality & character (P_{PC}), credibility (P_{CR}) and future potential (P_{F}).

Also in the present invention, each of the questions could have a predetermined weight of question, and the evaluation value of a specific sub-domain may be expressed by the following equation.

$${X}_{y y}^{″} = \frac{{\sum }_{k = 1}^{n} ( {a}_{k} \times {W}_{{a}_{k}} )}{{\sum }_{k = 1}^{n} {W}_{{a}_{k}}}$$

Wherein, X″_{yy} is the weighted evaluation value of the sub-domain X_{yy} to which the question-related weight is applied, aₖ and Wₐₖ are the response value, and the weight of the k-th question of the sub-domain X_{yy} respectively.

In addition, in the present invention, the weighted evaluation value applied with the weight of each sub-domain can be represented by Equation 4 to be described later.

In the present invention, each of the questions and each of the evaluators have a predetermined weight, and the evaluation value of a specific sub-domain by a specific evaluator may be expressed by the following equation.

$${X}_{y y}^{′′′} = \frac{{\sum }_{i = 1}^{j} ( {X}_{y {y}_{i}}^{″} \times {W}_{{T}_{i}} )}{{N}_{W T}}$$

Wherein, X′″_{yy} is the weighted evaluation value of sub-domain X_{yy} to which both the question-related weight and the evaluator-related weight are applied in an overlapped manner, X″_{yy} is the weighted evaluation value of sub-domain X_{yy} by the i-th evaluator to which only the question-related weight is applied, W_{Ti} is the weight synthesis of the evaluator-related weights of the i-th evaluator, N_{WT} is the sum of the evaluator-related weights of all evaluators for a single evaluatee.

In the present invention, the weight synthesis of the evaluator-related weights of the i-th evaluator W_{Ti} is expressed by the following equation.

$${W}_{{T}_{i}} = {W}_{f {1}_{i}} \times {W}_{{f2}_{i}} \times {W}_{f {3}_{i}}$$

Wherein, W_{f1}_{ᵢ}=LRᵢ×DRᵢ×FRᵢ, [LRᵢ, DRᵢ, FRᵢ are each the values for the level of the relationship, duration of relationship, frequency of relationship between the evaluatee and the i-th evaluator],

$${W}_{f {2}_{i}} = max ( 1 - \frac{a}{36 S \times y} , z ) ,$$

(0.0<W_{f2}_{ᵢ}≤1.0), [d is the number of elapsed days from the date of the evaluation value input based on the date of analysis of the i-th evaluator, y is the number of years at which the time weight of the evaluation value becomes the arbitrarily designated minimum value due to the passage of time, z is an arbitrary minimum weight value that is a real number greater than 0 and less than or equal to 1],

W_{f3i} is each the weight of the reputation value of the i-th evaluator himself/herself, a real number greater than 0 and less than or equal to 1.

In the present invention, the sum of evaluator-related weights of all evaluators for a specific evaluatee, N_{WT}, may be expressed by the following equation.

$${N}_{W T} = {\sum }_{i = 1}^{j} {W}_{{T}_{i}}$$

Wherein, j is the number of evaluators for a specific evaluatee.

The present invention allows social ability or reputation of an individual or a group to be evaluated by a number of evaluators around the evaluatee, and as the social ability or reputation of an individual or a group is analyzed with high reliability through the evaluation by a number of evaluators, and information on the evaluation is provided to individuals or groups who need the information under the authority of the evaluatee, there is an effect of objectively evaluating social reputation of an individual or a group.

In addition, as the present invention allows an evaluatee (evaluation result holder), who desires to use the evaluation valuably, and a result of the evaluation to be used for forming various relationships with the evaluatee, i.e., employment, financial activities, business, marriage, various contracts, and the like, there is an effect of creating a new business model.

Furthermore, the present invention has an effect of establishing a new social credit standard that complements incompleteness of evaluation of career and credit relying on criminal history, financial credit through financial institutions, inquiry of education level, recommendation letters, resumes, and the like.

### BRIEF DESCRIPTION OF THE DRAWINGS

FIG. 1 is a block diagram showing a system for evaluating the reputation of an individual or a group according to a preferred embodiment of the present invention.

Description of symbols

| | |
|---|---|
| 10: Evaluatee terminal | 20: Service server |
| 30: Evaluator terminal | 40: Viewer terminal |
| 50: Storage unit | |

### DETAILED DESCRIPTION

Hereafter, a system and method for evaluating the reputation of an individual or a group according to the present invention will be described in detail with reference to the accompanying drawings.

In present invention, ‘OOO terminal’ can refer to a specific physical terminal, or it could mean any terminal that connects or gets accessed using a specified authentication method to authenticate a legitimate user. In present invention, the term ‘terminal’ refers to an electronic device such as a smartphone, a tablet computer, a PC, a laptop computer, or the like, capable of communicating with the service server 20, installing an application provided by the service server 20, and accessing and registering in the service server 20 by executing the application.

Below will be the explanation of the components involved in present invention and their relationships, followed by the description of the process of calculating the evaluation value and assigning weights in the reputation evaluation system according to the present invention.

### 1. Components and Relationships of Present Invention

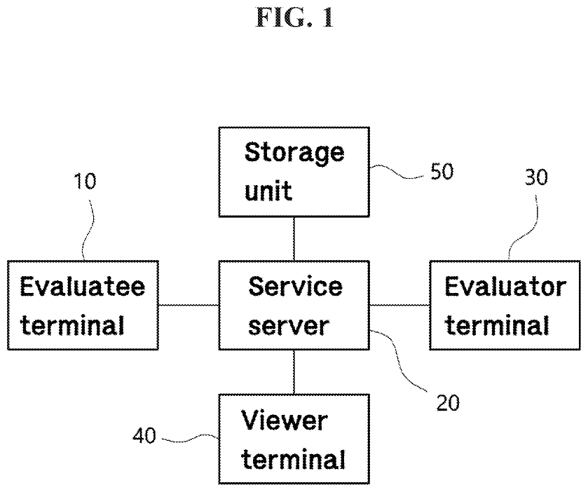

The present invention pertains to a reputation evaluation system for individuals or groups, which includes an evaluatee terminal 10, a service server 20, an evaluator terminal 30, a viewer terminal 40, and a storage unit 50. FIG. 1 is a block diagram showing a system for evaluating the reputation of an individual or a group according to a preferred embodiment of the present invention.

In present invention, the evaluatee terminal 10 is the terminal of the evaluatee who requests an evaluation of their social reputation. The evaluatee who wishes for a social reputation evaluation connects to the service server 20 using the evaluatee terminal 10 and requests a social evaluation. At this point, the evaluatee can specify one or more possible evaluators who evaluate the evaluatee's reputation by using the evaluator terminal 30.

As explained below, when the service server 20 specifies the qualification and/or the number of evaluators, the evaluatee designates appropriate evaluators or evaluator terminals.

In present invention, the service server 20 accepts the evaluation request from the evaluatee terminal 10, allows the evaluator terminal 30 designated by the evaluatee to connect and proceed with the evaluation, saves it in the storage unit 50, analyzes the evaluation results, and enables the results to be viewed by the evaluatee terminal 10 or viewer terminal 40.

The service server 20 provides information about the evaluatee to the designated evaluator. and confirms their intention to participate in the evaluation. At this time, the confirmation of intention can be through a dedicated application or by asking via SMS, email whether they would like to participate in the evaluatee's evaluation and confirm their participation. The service server 20 carries out the procedures necessary for the evaluation, such as transmitting questions for evaluating the evaluatee through application, SMS, email, and the like, to the evaluator terminals 30 that have decided to participate in the evaluation, receiving responses, and the like.

The service server 20 stores evaluator information including the information of the evaluator terminal 30 that participated in the evaluation, and other evaluation information in the storage unit 50.

The service server 20 can specify a minimum number of evaluators, classify the qualifications of the evaluators (i.e., the social relationship with the evaluatee, the reputation of the evaluator, etc.), put at least one evaluator in each category, or request a reason for input if there is no evaluator in that category. In order to ensure the objectivity of the evaluation results, the service server 20 can set a standard for the minimum number of evaluators. For example, it can set a minimum number of evaluators to 20 or 30. If the number of evaluators participating in the evaluation does not meet the set minimum number of evaluators, the evaluation request may be rejected, or a corrected evaluation result may be provided.

The input data from the evaluators stored in the service server 20 can be used to analyze the evaluation results per evaluator classification for the evaluatee, or to apply different weights per evaluator classification to derive the comprehensive evaluation result. In other words, the service server 20 verifies and analyzes the response value from questions and calculates the social reputation of the evaluator. Meanwhile, the main categories and sub-categories of the social relationship can be used as a basis for calculating the relationship weight of each evaluator. To this end, the service server 20 can provide a set electronic resume form to verify the social relationship and receive its input, and a weighted value due to relationship weight can be automatically calculated through a comparison of the electronic resume forms. The application of predetermined correction factors to correct the evaluation results will be described in detail later.

In present invention, the evaluator terminal 30 is a component that accepts the evaluation request from the evaluatee terminal 10 via service server 20 and responds to the evaluation request provided by the service server 20. Upon receiving a request from the service server 20 to participate in the evaluation for the evaluatee, and deciding to participate in the evaluation, they answer (=respond, evaluate) the questions presented by the service server 20 following predetermined procedures and methods. That is, the evaluator answers the questions and sends this to the service server 20 using the evaluator terminal 30.

Regarding the evaluator's qualifications, the evaluator can be a human resource officer or a manager with the right to evaluate within the group to which the evaluatee belongs, or a colleague. Further extending, a user of the evaluator terminal 30, i.e., anyone specified under the authority of the evaluatee, such as a family member, relative, friend, teacher, neighbor, or acquaintance on a social network of the user of the evaluator terminal 10, may be an evaluator.

Response data (evaluation values) created by the evaluator terminal 30 are stored in the storage unit 50 of the service server 20 and go through a predetermined processing process.

In present invention, the viewer terminal 40 becomes a user who needs the evaluated reputation value of the evaluatee, and can request the service server 20 to allow to view the reputation value for the specific evaluatee. The user of the viewer terminal 40 may be corporations, government offices, banks, schools, individuals, etc., who proceed with tasks such as employment, agreements, loans, and the like, considering the social evaluation of the evaluatee.

In present invention, the storage unit 50 stores various information related to the evaluatee, evaluator, evaluation value (evaluation information), and viewer.

In addition to the service of analyzing and viewing using the evaluation information stored in the storage unit 50, the service server 20 may generate a blockchain ledger in response to the evaluation request of the evaluatee terminal 10. The blockchain ledger basically includes information on the evaluatee and the evaluator. The recorded ledger may be distributed to systems constituting a private blockchain. Basically, the evaluatee terminal 10 has a right to view the stored blockchain ledger, and the viewing may be performed by the service server 20 to prevent tampering and to confirm that the evaluation information is not tampered.

Thus, the present invention may prevent leakage of personal information by preventing manipulation of evaluation results using blockchain techniques and limiting access of non-authorized users.

Regarding information access, it can proceed as follows:

On default, the evaluatee terminal 10 has the right to view the evaluation result analyzed based on the stored evaluation information. In other words, the evaluatee has a right to request and approve viewing the evaluation result information for the viewer terminal 40 and can limit the right to view the evaluation results to only the specified range according to the viewer. Accordingly, domain-specific evaluation results or comprehensive evaluation results can be provided to the viewer terminal 40 specified by the evaluatee terminal 10. Specification of the viewer terminal 40 by the evaluatee can be initiated by a request of the viewer terminal 40 or the evaluatee terminal 10.

The service server 20 allows the qualified viewer to view the specified evaluation results, based on evaluatee's request and approval.

### 2. Process of Reputation Evaluation by the Present Invention

The reputation evaluation process of the present invention can be explained in detail as follows:

First, reputation evaluation can be classified into major domains and sub-domains.

The major domain can be divided into a personal relationship reputation (E) domain and a public relationship reputation (P) domain according to the social relationship.

The social relationship can be divided into private and public relationships, and such social relationships can be automatically verified through comparison of electronic resume forms provided by the service server 20.

In the social relationship, the public relationship can be further divided into sub-categories such as employer, manager, work colleague (simple relationship), work colleague (collaborative relationship), and collaborative relationship in the same field outside the workplace, or the like. In the social relationship, the private relationship can be further divided into sub-categories such as a family member, relative, friend, teacher, neighbor, or acquaintance on a social network, or the like. When an evaluatee is not a natural person (individual) but a group such as a corporation, the kinds of public relationship sub-categories may be an executive and an employee of a corresponding group, an executive and an employee of a related group, or the like, and the kinds of private relationship sub-categories may be a client, a stockholder, or the like.

The social relationship can also be divided according to the point in time (current, past) of the relevant relationship, the duration of the relationship, and the frequency of the relationship.

The type and degree of such social relationships between the evaluatee and the evaluator are used as a basis for calculating the weight related to each evaluator.

The sub-domain can have fairness, trust, honesty, sincerity, concentration/achievement on goals, affinity, collaboration ability, altruism, future potential, and the like as evaluation factors, but it is not limited to this. It should be obvious that the sub-domain can be added or changed as needed. However, for the convenience of explanation, in the following, we will limit the sub-domains to three domains: personality & character (If the evaluatee is a group like a corporation, it can be the characteristics of the group's culture, governance structure and the like), credibility, and future potential, and E_{PC}, E_{CR}, E_{F}, P_{PC}, P_{CR}, P_{F} are exemplified. The attributes of the sub-domain showed by the subscript represent the evaluation elements of PC (personality & character), CR (credibility), F (future potential). The types of evaluation factors for each question are summarized in the table below. The raw evaluation value of the without applying weight to the evaluator's response is expressed by adding an apostrophe to the first letter of the abbreviation of the question.

| Major Domain | Sub-domain | Abbreviation | Raw Evaluation Value |
|---|---|---|---|
| personal | personality & | E_{PC} | E′_{PC} |
| relationship | character (PC) | | |
| reputation (E) | credibility (CR) | E_{CR} | E′_{CR} |
| | future potential (F) | E_{F} | E′_{F} |
| public relationship | personality & | P_{PC} | P′_{PC} |
| reputation (P) | character (PC) | | |
| | credibility (CR) | P_{CR} | P′_{CR} |
| | future potential (F) | P_{F} | P′_{F} |

For the convenience of explanation and to prevent confusion, the related equations are represented in a simplified form of X_{yy} that stands for each sub-domain, and they are also indicated as equations that apply to each sub-domain.

To avoid confusion, the meanings of the key symbols used hereafter are organized.

| Symbol | Meaning |
|---|---|
| X_{yy} | Any one of the sub-domains E_{pc}~P_{f} |
| X′_{yy} | Unweighted raw evaluation value of sub-domain X_{yy} |
| X″_{yy} | Weighted evaluation value of sub-domain X_{yy} |
| | with question-related weights |
| X″′_{yy} | Weighted evaluation value of sub-domain X_{yy} with |
| | question-related weights, evaluator-related weights, and |
| | evaluation time point-related weights |
| aₖ | Response value of the k-th question in sub-domain X_{yy} |
| a1ₖ~a6ₖ | Response value of the k-th question in each sub-domain |
| | E_{pc~}P_{f} |
| Waₖ | Weight of the k-th question in sub-domain X_{yy} |
| Wₐ₁ₖ~Wₐ₆ₖ | Weight of the k-th question in each sub-domain E_{pc}~P_{f} |

Each evaluator evaluates the questions of the sub-domain belonging to one of the major domains according to their relationship with the evaluatee.

When the number of questions for the sub-domain is n, the raw evaluation value of the sub-domain can be represented as Equation 1 below, and each of the six sub-domains in the above table can be expressed as Equation 2.

$${X}_{y y}^{′} = \frac{{\sum }_{k = 1}^{n} {a}_{k}}{n} \qquad [ Equation 1 ]$$

[X′_{yy} is the raw evaluation value of the sub-domain X_{yy} where the question-related weight is not applied, aₖ is the k-th response value]

$${E}_{p c}^{′} = \frac{{\sum }_{k = 1}^{n} a {1}_{k}}{n} , \qquad [ Equation 2 ]$$

$${E}_{c r}^{′} = \frac{{\sum }_{k = 1}^{n} a {2}_{k}}{n} ,$$

$${E}_{f}^{′} = \frac{{\sum }_{k = 1}^{n} a {3}_{k}}{n} ,$$

$${P}_{p c}^{′} = \frac{{\sum }_{k = 1}^{n} a {4}_{k}}{n} ,$$

$${P}_{c r}^{′} = \frac{{\sum }_{k = 1}^{n} a {S}_{k}}{n} ,$$

$${P}_{f}^{′} = \frac{{\sum }_{k = 1}^{n} a {6}_{k}}{n}$$

[E′_{pc}˜P′_{f} is the raw evaluation value of sub-domain E_{pc}˜P_{f} where the weight is not applied, a1ₖ˜a6ₖ is the response value of the k-th question of each sub-domain E_{pc}˜P_{f}]

Meanwhile, as mentioned earlier, in present invention, the service server 20 can apply predetermined correction factors to correct the evaluation results.

The correction factors may largely include a qualification factor of an evaluator and a reliability factor of data.

The qualification factor of an evaluator may be the nature of relationship (friend, family, mixed personal and business relationship, purely business relationship, and the like), the duration of relationship, the evaluation pattern of the evaluator, and the evaluation score factor of the evaluator himself/herself. At this point, response value input by the individual evaluator may be applied to calculation of a reputation result of the evaluatee as a differentiated weight is applied according to the qualification factor of a corresponding evaluator.

In addition, the amount of data and the homogeneity of data may be used for reliability of data. Reliability of data may be corrected by a differentiated weight based on the data retention period according to the generation time point of individual evaluation data.

As various measures have been suggested to detect and resolve the causes and effects of insufficient effort responding or careless responding that occurs when survey respondents do not pay enough effort and attention to the survey in conventional surveys and the like, it may be possible to adopt such conventional techniques to quantify and utilize the credibility of the response data.

Hereafter, the application of predetermined question-related weights that reflect the importance of each question, predetermined evaluator-related weights, or evaluation time point-related weights depending on the evaluator or evaluation point among various possible correction factors will be explained in order.

### (1) Question-Related Weight

When the response value of the k-th question in the sub-domain X_{yy} and the question-related weight are respectively denoted as aₖ and Wₐₖ, the response values entered by one evaluator for the evaluatee for each question go through a mathematical process combined with each weight of corresponding question, and are calculated as the weighted evaluation value of the sub-domain.

For example, the question-relating weighted evaluation value of a sub-domain with n questions can be represented by Equation 3 below, and each question-relating weighted evaluation value of the sub-domain can be expressed as Equation 4.

$${{X}^{″}}_{yy} = \frac{{\sum }_{k = 1}^{n} ( {a}_{k} \times {W}_{{a}_{k}} )}{{\sum }_{k = 1}^{n} {W}_{{a}_{k}}} \qquad [ Equation 3 ]$$

[X″_{yy} is the weighted evaluation value of sub-domain X_{yy} with question-related weights, aₖ and Wₐₖ are the response value and the weight of the question, respectively, of the k-th question in subdomain X_{yy}]

$${{E}^{″}}_{pc} = \frac{{\sum }_{k = 1}^{n} ( a {1}_{k} \times {W}_{a {1}_{k}} )}{{\sum }_{k = 1}^{n} {W}_{a {1}_{k}}} , \qquad [ Equation 4 ]$$

$${{E}^{″}}_{cr} = \frac{{\sum }_{k = 1}^{n} ( a {2}_{k} \times {W}_{a {2}_{k}} )}{{\sum }_{k = 1}^{n} {W}_{a {2}_{k}}} ,$$

$${{E}^{″}}_{f} = \frac{{\sum }_{k = 1}^{n} ( a {3}_{k} \times {W}_{a {3}_{k}} )}{{\sum }_{k = 1}^{n} {W}_{a {3}_{k}}} ,$$

$${{P}^{″}}_{pc} = \frac{{\sum }_{k = 1}^{n} ( a {4}_{k} \times {W}_{a {4}_{k}} )}{{\sum }_{k = 1}^{n} {W}_{a {4}_{k}}} ,$$

$${{P}^{″}}_{cr} = \frac{{\sum }_{k = 1}^{n} ( a {5}_{k} \times {W}_{a {5}_{k}} )}{{\sum }_{k = 1}^{n} {W}_{a {5}_{k}}} ,$$

$${{P}^{″}}_{f} = \frac{{\sum }_{k = 1}^{n} ( a {6}_{k} \times {W}_{a {6}_{k}} )}{{\sum }_{k = 1}^{n} {W}_{a {6}_{k}}}$$

[E″_{pc}˜P″_{f} is the weighted evaluated values of subdomains E_{pc}˜P_{f} with question-related weights, a1ₖ˜a6ₖ and Wₐ₁ₖ˜Wₐ₆ₖ are the response value and the weight of the question, respectively, of the k-th question in subdomains E_{pc}˜P_{f}]

### (2) Evaluator-Related Weight

In the present invention, various evaluator-related weights can be applied in addition to the aforementioned ‘question-related weights Waₖ’. These evaluator-related weights are applied to the overall personal relationship reputation (E) or public relationship reputation (P), which are major domains of evaluation.

In the present invention, in order to apply different weights according to the classification of the social relationship, the evaluators may be subdivided into main categories (nature of relationship) and sub-categories. These types and degrees of social relationships between an evaluatee and an evaluator are used as the basis for calculating each evaluator-related weight.

For example, the relationship weight W_{f1} may be a weight that reflects the ‘level of relationship (LR)’, ‘duration of relationship (DR)’, ‘frequency of relationship (FR)’ in the social relationship. The above LR, DR, FR indices have a predetermined value between 0 and 1. The value W_{f1} derived therefrom may be expressed as shown in Equation 5.

$${W}_{f 1} = LR \times DR \times FR , ( 0. \leq {W}_{f 1} \leq 1. ) \qquad [ Equation 5 ]$$

As another weight, ‘evaluator's reputation weight (W_{f3})’ determined by the reputation possessed by the evaluator may be applied. In this case, evaluation value input by an evaluator with a high reputation is regarded as being more important than evaluation value input by an evaluator with a low reputation.

For example, when the evaluation value of an evaluator in a specific sub-domain is x and the scale of the evaluation value is 10, W_{f3} of the evaluator in the sub-domain may be x/10 or an arbitrary value proportional to x/10, and W_{f3} may be a real number greater than 0 and equal to or smaller than 1.

### (3) Evaluation Time Point-Related Weight

In addition, In the present invention, the ‘weight of time (W_{f2})’ may be applied. The reputation of the evaluator may be reflected in the overall result with a different importance according to the period elapsed after the input. As the reputation of an evaluatee may vary over time, past evaluation values and latest evaluation values may be assigned with a different importance in the overall result.

For example, when it is assumed that the current evaluation value has the maximum weight (W_{f2}=1) according to the input time point of the evaluation value, and the proportion of the evaluation value calculated as 9 years or earlier (or belonging to the year of 10th anniversary or earlier, y) is 1/10 (W_{f2}=0.1), which is the minimum value, the ‘weight of time (W_{f2})’ may be calculated through Equation 6 shown below.

$${W}_{f 2} = max ( 1 - \frac{d}{365 \times y} , z ) , ( 0. < {W}_{f 2} \leq 1. ) \qquad [ Equation 6 ]$$

In Equation 6, d denotes the number of days elapsed from the input date of the evaluation value until the analysis date. In the above equation, y denotes the number of years taken for the weight of the time of the evaluation value to become a randomly specified minimum value over time. In the above equation, z denotes an arbitrary minimum weight value, which may be a real number greater than 0 and equal to or smaller than 1.

That is, when y is set to 10 years in the equation, the ‘weight of time (W_{f2})’ is reduced by a ratio of 1/3650 daily from the date of input. At this point, the ‘weight of time (Wf2)’ for the evaluation value becomes z at the time point when 9 years or more have passed, and Wf2 after this time point is fixed to the weight of z, which is the minimum weight. The elapsed time for adjustment of weight and the minimum weight value may be randomly specified. For example, z may be a real number greater than 0 and smaller than or equal to 1.

### (4) Comprehensive Reflection of Weight

Although W_{f1}, W_{f2}, and W_{f3} shown in the above equation may be processed in an evaluation without regard to the sub-domains and the number of questions, when j evaluators input evaluation values for one evaluatee, as many as j different W_{f1}, W_{f2}, and W_{f3} may be generated.

W_{f1}, W^{f2}, W_{f3} are weights such as the evaluator's relationship classification, the time point of the evaluation created by the evaluator, and the evaluator's reputation, and the weight synthesis (WT) combining these can be defined. In the evaluation of one evaluatee, j evaluators create j types of WT.

W_{f1}, W_{f2}, and W_{f3} are weights related to classification of evaluator's relationship, a time point of an evaluation value generated by the evaluator and evaluator's reputation, and a weight synthesis W_{T} combining the weights may be defined. In the evaluation of one evaluatee, j evaluators create j types of W_{T}.

The equation in Equation 7 has written the equation for calculating the weight synthesis of the evaluator-related weight and evaluation time point-related weight for the i-th evaluator.

$${W}_{{T}_{i}} = {W}_{f {1}_{i}} \times {W}_{f {2}_{i}} \times {W}_{f {3}_{i}} \qquad [ Equation 7 ]$$

The sum of evaluator-related and evaluation timing-related weights (N_{WT}) for all evaluators for one evaluatee may be regarded as the size of an actual evaluation group, and may be expressed as shown in Equation 8.

$${N}_{WT} = {\sum }_{i = 1}^{j} {W}_{Ti} \qquad [ Equation 8 ]$$

When j evaluators input response values of a sub-domain configured of the n questions, j amount of X″_{yy}(Weighted evaluation value with question-related weights) may be generated for each sub-domain. By dividing the sum of the values to which the evaluator-related weight W_{T} is applied by the size of the actual evaluation group, N_{WT}, X′″_{yy} for each sub-domain, which reflects both the question-related weight and the evaluator-related weight, can be obtained.

The final equation of the weighted evaluation value can be represented by Equation 9 below, and for each sub-domain, it can be expressed as Equation 10.

$${{X}^{′′′}}_{yy} = \frac{{\sum }_{i = 1}^{j} ( X {″}_{{yy}_{i}} \times {W}_{{T}_{i}} )}{{N}_{WT}} \qquad [ Equation 9 ]$$

Wherein, X′″_{yy} is the weighted evaluation value of sub-domain X_{yy} with a combination of the question-related weights, evaluator-related weights, and evaluation time point-related weights, X″_{yyi} is the weighted evaluation value of the sub-domain X_{yy} by the i-th evaluator with only the question-related weight is applied, W_{Ti} is the evaluator-related weight synthesis of the i-th evaluator, N_{WT} is the sum of the evaluator-related weights of all evaluators for one evaluate.

$${{E}^{′′′}}_{pc} = \frac{{\sum }_{i = 1}^{j} ( {{E}^{″}}_{{pc}_{i}} \times {W}_{{T}_{i}} )}{{N}_{WT}} , \qquad [ Equation 10 ]$$

$${{E}^{′′′}}_{cr} = \frac{{\sum }_{i = 1}^{j} ( {{E}^{″}}_{{cr}_{i}} \times {W}_{{T}_{i}} )}{{N}_{WT}} ,$$

$${{E}^{′′′}}_{f} = \frac{{\sum }_{i = 1}^{j} ( {{E}^{″}}_{{f}_{i}} \times {W}_{{T}_{i}} )}{{N}_{WT}} ,$$

$${{P}^{′′′}}_{pc} = \frac{{\sum }_{i = 1}^{j} ( {{P}^{″}}_{{pc}_{i}} \times {W}_{{T}_{i}} )}{{N}_{WT}} ,$$

$${{P}^{′′′}}_{cr} = \frac{{\sum }_{i = 1}^{j} ( {{P}^{″}}_{{cr}_{i}} \times {W}_{{T}_{i}} )}{{N}_{WT}} ,$$

$${{P}^{′′′}}_{f} = \frac{{\sum }_{i = 1}^{j} ( {{P}^{″}}_{{f}_{i}} \times {W}_{{T}_{i}} )}{{N}_{WT}} ,$$

Wherein, E′″_{pc}˜P′″_{f} each are the weighted evaluation values of sub-domain E_{pc}˜P_{f} with a combination of the question-related weights and the evaluator-related weights applied, E″_{pci}˜P″_{fi} is the weighted evaluation value of the sub-domain E_{pc}˜P_{f} by the i-th evaluator with only the question-related weights applied, W_{Ti} is the evaluator-related weight synthesis of the i-th evaluator, N_{WT} is the sum of the evaluator-related weights of all evaluators for one evaluate.

Additional predetermined weights may also be considered when calculating the evaluation values from the sub-domains such as E′″_{pc}, which are composed of n questions with varying weights, which were assessed by j evaluators with different weights (Wf1, Wf2, Wf3) for the respective evaluatee, to the major domains (E, P)

It is obvious to those skilled in the art that the present invention is not limited to the above embodiments and may be implemented to be variously changed or modified within the scope of the technical gist of the present invention.

1-6. (canceled)

7. A social reputation evaluation system for individuals or groups comprising:
an evaluatee terminal where the evaluatee connects to the following service server to request an evaluation of his/her social reputation;
a service server that receives an evaluation request from the evaluatee via the evaluatee terminal, stores the response values submitted by the evaluator for the given questions for evaluating the reputation through the undermentioned evaluator terminal, analyzes the response values to derive evaluation values, and allows the evaluation values to be viewed through the evaluatee terminal or the following viewer terminal;
an evaluator terminal, which is predetermined, where the evaluator submits response values to the questions provided by the service server; and
a viewer terminal, where the viewer views the evaluation values for the evaluatee from the service server.

8. A social reputation evaluation method for individuals or groups performed in the system according to claim 7, wherein
the service server requires the qualifications of the evaluator and the minimum number of evaluators for each type of questions when the evaluation is requested,
the evaluatee, when requesting the evaluation, designates an evaluator who satisfies the qualifications and numbers required by the service server,
a service server provides information about the evaluatee to the designated evaluator terminal to confirm to participate in the evaluation, and sends questions to the evaluator terminal that has confirmed to participate.

9. The method according to claim 8, wherein the service server provides a predetermined electronic resume form to the evaluatee and the evaluator to confirm the social relationship between the evaluatee and the evaluator, and receives their input.

10. The method according to claim 8, wherein the questions are classified into two major domains of questions for private relationship reputation (E) and public relationship reputation (P), depending on the social relationship.

11. The method according to claim 10, wherein each major domains are divided into sub-domains for the reputations selected from a group comprising personality & character, credibility, future potential, fairness, trust, honesty, sincerity, concentration/achievement on goals, affinity, collaboration ability and altruism.

12. The method according to claim 11, wherein the major domain for the private relationship reputation (E) is divided into sub-domains for the reputations on personality & character (E_{PC}), credibility (E_{CR}) and future potential (E_{F}),
the major domain for the public relationship reputation (P) is divided into sub-domains for the reputations on personality & character (P_{PC}), credibility (P_{CR}) and future potential (P_{F}).

13. The method according to claim 12, wherein each of the questions has a predetermined weight of question, and the evaluation value of a specific sub-domain is expressed by the following equation:
$${{X}^{″}}_{yy} = \frac{{\sum }_{k = 1}^{n} ( {a}_{k} \times {W}_{{a}_{k}} )}{{\sum }_{k = 1}^{n} {W}_{{a}_{k}}}$$
wherein, X″_{yy} is the weighted evaluation value of the sub-domain X_{yy} to which the question-related weight is applied, aₖ and Waₖ are the response value, and the weight of the k-th question of the sub-domain X_{yy} respectively.

14. The method according to claim 13, wherein the weighted evaluation values of each sub-domain are expressed by the following equation:
$${{E}^{″}}_{pc} = \frac{{\sum }_{k = 1}^{n} ( a {1}_{k} \times {W}_{a {1}_{k}} )}{{\sum }_{k = 1}^{n} {W}_{a {1}_{k}}} ,$$
$${{E}^{″}}_{cr} = \frac{{\sum }_{k = 1}^{n} ( a {2}_{k} \times {W}_{a {2}_{k}} )}{{\sum }_{k = 1}^{n} {W}_{a {2}_{k}}} ,$$
$${{E}^{″}}_{f} = \frac{{\sum }_{k = 1}^{n} ( a {3}_{k} \times {W}_{a {3}_{k}} )}{{\sum }_{k = 1}^{n} {W}_{a {3}_{k}}} ,$$
$${{P}^{″}}_{pc} = \frac{{\sum }_{k = 1}^{n} ( a {4}_{k} \times {W}_{a {4}_{k}} )}{{\sum }_{k = 1}^{n} {W}_{a {4}_{k}}} ,$$
$${{P}^{″}}_{cr} = \frac{{\sum }_{k = 1}^{n} ( a {5}_{k} \times {W}_{a {5}_{k}} )}{{\sum }_{k = 1}^{n} {W}_{a {5}_{k}}} ,$$
$${{P}^{″}}_{f} = \frac{{\sum }_{k = 1}^{n} ( a {6}_{k} \times {W}_{a {6}_{k}} )}{{\sum }_{k = 1}^{n} {W}_{a {6}_{k}}}$$
wherein, E″_{pc}˜P″_{f} is the weighted evaluation value of the sub-domain E_{pc}˜P_{f} to which the question-related weight is applied, a1ₖ˜a6ₖ and Wₐ₁ₖ˜Wₐ₆ₖ are the response value and the weight of the question of the k-th question of the sub-domain E_{pc}˜P_{f}, respectively.

15. The method according to claim 12, wherein each of the questions and each of the evaluators have a predetermined weight, and the evaluation value of a specific sub-domain by a specific evaluator is expressed by the following equation:
$${{X}^{′′′}}_{yy} = \frac{{\sum }_{i = 1}^{j} ( {{X}^{″}}_{{yy}_{i}} \times {W}_{{T}_{i}} )}{{N}_{WT}}$$
wherein, X′″_{yy} is the weighted evaluation value of sub-domain X_{yy} to which both the question-related weight and the evaluator-related weight are applied in an overlapped manner, X″_{yyi} is the weighted evaluation value of sub-domain X_{yy} by the i-th evaluator to which only the question-related weight is applied, W_{Ti} is the weight synthesis of the evaluator-related weights of the i-th evaluator, N_{WT} is the sum of the evaluator-related weights of all evaluators for a single evaluatee.

16. The method according to claim 15, wherein the weighted evaluation values with weights applied to each sub-domain are expressed by the following equation:
$${{E}^{′′′}}_{pc} = \frac{{\sum }_{i = 1}^{j} ( {{E}^{″}}_{{pc}_{i}} \times {W}_{{T}_{i}} )}{{N}_{WT}} ,$$
$${{E}^{′′′}}_{cr} = \frac{{\sum }_{i = 1}^{j} ( {{E}^{″}}_{{cr}_{i}} \times {W}_{{T}_{i}} )}{{N}_{WT}} ,$$
$${{E}^{′′′}}_{f} = \frac{{\sum }_{i = 1}^{j} ( {{E}^{″}}_{{f}_{i}} \times {W}_{{T}_{i}} )}{{N}_{WT}} ,$$
$${{P}^{′′′}}_{pc} = \frac{{\sum }_{i = 1}^{j} ( {{P}^{″}}_{{pc}_{i}} \times {W}_{{T}_{i}} )}{{N}_{WT}} ,$$
$${{P}^{′′′}}_{cr} = \frac{{\sum }_{i = 1}^{j} ( {{P}^{″}}_{{cr}_{i}} \times {W}_{{T}_{i}} )}{{N}_{WT}} ,$$
$${{P}^{′′′}}_{f} = \frac{{\sum }_{i = 1}^{j} ( {{P}^{″}}_{{f}_{i}} \times {W}_{{T}_{i}} )}{{N}_{WT}}$$
wherein, E′″_{pc}˜P′″_{f} are each the weighted evaluation values of sub-domain E_{pc}˜P_{f} to which both the question-related weight and the evaluator-related weight are applied in an overlapped manner, E″_{pci}˜P″_{fi} is the weighted evaluation value of sub-domain E_{pc}˜P_{f} by the i-th evaluator to which only the question-related weight is applied, W_{Ti} is the weight synthesis of the evaluator-related weights of the i-th evaluator, N_{WT} is the sum of the evaluator-related weights of all evaluators for a single evaluatee.

17. The method according to claim 15, wherein the weight synthesis of the evaluator-related weights of the i-th evaluator W_{Ti} is expressed by the following equation:
$${W}_{{T}_{i}} = {W}_{f {1}_{i}} \times {W}_{f {2}_{i}} \times {W}_{f {3}_{i}}$$
wherein, W_{f1}_{ᵢ}=LRᵢ×DRᵢ×FRᵢ, here, LRᵢ, DRᵢ, FRᵢ are each the values for the level of the relationship, duration of relationship, frequency of relationship between the evaluatee and the i-th evaluator,
$${W}_{f {2}_{i}} = max ( 1 - \frac{d}{365 \times y} , z ) ,$$
(0.0<W_{f2}_{ᵢ}≤1.0), here, d is the number of elapsed days from the date of the evaluation value input based on the date of analysis of the i-th evaluator, y is the number of years at which the time weight of the evaluation value becomes the arbitrarily designated minimum value due to the passage of time, z is an arbitrary minimum weight value that is a real number greater than 0 and less than or equal to 1,
W_{f3i} is each the weight of the reputation value of the i-th evaluator himself/herself, a real number greater than 0 and less than or equal to 1.

18. The method according to claim 15, wherein the sum of evaluator-related weights of all evaluators for a specific evaluatee, N_{WT}, is expressed by the following equation:
$${N}_{WT} = {\sum }_{i = 1}^{j} {W}_{Ti}$$
wherein, j is the number of evaluators for a specific evaluatee.
